(19) United States
(12) Patent Application Publication
(10) Pub. No.: US 2009/0293248 A1
(43) Pub. Date: Dec. 3, 2009

(54) TANGED INSERT INSERTION TOOL

(75) Inventor: Takashi SATO, Kashiwazaki-shi (JP)

Correspondence Address: THOMPSON HINE L.L.P.;Intellectual Property Group, P.O. BOX 8801, DAYTON, OH, 45401-8801, US

(73) Assignee: ADVANEX INC., Tokyo (JP)

(21) Appl. No.: 12/475,844

(22) Filed: Jun. 1, 2009

(30) Foreign Application Priority Data
Jun. 3, 2008 (JP) P2008-145902

(51) Int. Cl. B25B 27/14

(52) U.S. Cl. 29/240.5

(57) ABSTRACT

A tanged insert insertion tool is able to be used with both manually driven systems and automatically driven systems while having a simple structure. This tanged insert insertion tool is comparatively low in cost and is able to reliably prevent pitch jump from occurring. A tanged insert insertion tool 10 has a tubular housing 11 and a mandrel 12 which is inserted inside the housing 11 such that a distal end portion thereof protrudes from one end side of the housing 11. An external thread portion 20 is threaded together with a tanged insert on the distal end portion of the mandrel 12.

### BACKGROUND OF THE INVENTION

1. Field of the Invention

The present invention relates to a tanged insert insertion tool which is used to mount a tanged insert in a tapped hole in a base material.

Priority is claimed on Japanese Patent Application No. 2008-145902, filed Jun. 3, 2008, the contents of which are incorporated herein by reference.

2. Description of Related Art

A tanged insert is known as an apparatus for forming a high-strength internal thread in a base material which is made from a brittle material having comparatively low strength such as resin or aluminum (see, for example, Japanese Patent Application Laid-Open (JP-A) No. 2000-61860).

A tanged insert is formed from conventional wire in a coil which has an external thread and an internal thread formed respectively on an outer circumferential surface and an inner circumferential surface thereof, and has a catching portion known as a tang which is bent inwards formed at one end portion thereof. In addition, a notch used for breaking off the tang is formed adjacent to the tang in this tanged insert. As a result, in this tanged insert, after the insert has been inserted into a tapped hole (i.e., an internal thread portion) formed in advance in a substrate, by using the notch to break off the tang, the tang does not form any obstruction when a bolt is screwed into the insert.

When this type of tanged insert is inserted into a tapped hole in a base material, conventionally, a tool is used which principally utilizes a method known as a prewinder method. This prewinder type of tool is formed by mounting a fastening nut on a distal end portion of a prewinder body which is formed by a cylindrical body. Before the tanged insert is inserted into a tapped hole in a base material, the insert is first inserted into the nut. This allows the insert to be easily inserted into the tapped hole (i.e., the internal thread portion) via a screwing-tight action. Note that known examples of this type of prewinder tool include manually driven types and automatic types which are equipped with a power driver.

Moreover, in addition to a prewinder type of tool, a slot type of insertion tool which resembles a prewinder type is also known (see, for example, Japanese Patent Application Laid-Open (JP-A) No. 2000-61860). Compared with a prewinder type of tool in which a fastening nut is mounted on the distal end portion of the prewinder body, as is shown in FIG. 7A, in this insertion tool, an internal thread portion 2 is formed integrally with the distal end portion of a tube body 1. Namely, in this insertion tool, a shaft body 3 is retractably inserted inside the tube body 1 and, as is shown in FIG. 7B, a tang T of a tanged insert TI is held in a groove 4 which is formed in a distal end surface of this shaft body 3. In this state, as is shown in FIG. 7A, the shaft body 3 is rotated so that it moves forward and passes through the internal thread portion 2, and in this state it is inserted into a tapped hole 5 formed in a base material and is screwed inside this tapped hole 5.

However, in the above described prewinder type of tool, because it is necessary to mount a fastening nut, the structure is complex and a large number of assembly steps are consequently required which leads to increased manufacturing costs. Furthermore, there are both manually driven and automatically driven types, and in order to be able to use both tools as is needed, it is necessary to provide both tools which causes the cost to a user to increase and creates a considerable burden.

Moreover, in the above described slot type of insertion tool, when the insert TI is inserted into the tap hole 5 and is screwed into it, as is shown in FIG. 7A, there may be cases in which the pitch of the insert T1 jumps over the ridges of the internal thread in the tap hole 5 so that the respective pitches do not fit consecutively inside the internal thread but instead are screwed in out of alignment with the internal thread. This phenomenon is known as ‘pitch jump’. This type of pitch jump is extremely troublesome to an operator when it occurs, and considerable time is needed in order to perform a recovery operation. Because of this, pitch jump is the cause of conspicuous delays during operations to mount an insert. Moreover, this type of pitch jump is in many cases not noticed when an insert TI is being inserted and if the insertion operation continues unchecked, then when a bolt is fitted into the insert, the bolt cannot be screwed in properly, and the subsequent recovery operation is extremely difficult and time consuming.

### SUMMARY OF THE INVENTION

The present invention was conceived in view of the above described circumstances and it is an object thereof to provide an insertion tool for a tanged insert which has a simple structure which allows it to be driven both manually and automatically, and which is comparatively cheap and is able to reliably prevent pitch jump from occurring.

The tanged insert insertion tool of the present invention includes a housing and a mandrel which is inserted inside the housing such that a distal end portion thereof protrudes from one end side of the housing, wherein an external thread portion which is threaded together with a tanged insert is provided on the distal end portion of the mandrel.

According to this tanged insert insertion tool, because an external thread portion is provided at the distal end portion of the mandrel, even without a fastening nut such as is used in a conventional prewinder type tool, it is possible to prevent pitch jump from occurring by screwing a tanged insert into a tapped hole while the insert is screwed onto the external thread portion.

Moreover, because the fastening nut is no longer required due to the external thread portion being formed on the distal end portion of the mandrel, disadvantages such as a complex structure and high manufacturing costs which are inherent in a conventional prewinder type tool can be eliminated, resulting in a simplified structure and a low-cost tool being obtained.

Moreover, because the structure is simple in that an external thread portion is simply formed on the distal end portion of the mandrel, it can be used with both manually driven systems and automatically driven systems.

In the above described tanged insert insertion tool, it is also preferable for one coil at an endmost potion of the external thread portion to form an engaging portion which is formed in a helically wound spiral shape.

By employing this type of structure, when the external thread portion is screwed into the tanged insert, the engaging portion is able to properly mesh together with the tang and is securely engaged with the tang. Accordingly, it is easy to insert the tanged insert in a tapped hole and screw it into this hole. Moreover, after the tanged insert has been inserted and screwed in, by then unwinding the external thread portion in the opposite direction from the screwing-in direction, then engagement of the engaging portion with the tang is easily released. Accordingly, it is possible to easily extract only the mandrel from the tapped hole.

In the above described tanged insert insertion tool, it is also preferable for a guard which is manufactured from resin in the shape of a circular cylinder having a closed lid to cover one end side of the housing, and for the distal end portion of the mandrel to protrude from the one end side of the housing through a through hole which is formed in the guard.

By employing this type of structure, when the tanged insert is inserted and screwed into a tapped hole when the insert has been threaded together with the external thread portion, the guard functions as a shock absorber by coming into contact with the base material in which the tapped hole is formed. In addition, the guard functions as a stopper to determine the insertion depth of the distal end portion of the mandrel.

In the above described tanged insert insertion tool, it is also preferable for there to be provided a protrusion length adjustment mechanism which adjusts the length of the distal end portion which is protruding from the one end side of the housing.

By employing this type of structure, the distal end portion of the mandrel can be inserted for the required length into a tapped hole formed in a base material. Accordingly, the insertion and screwing-in of a tanged insert into a tapped hole is made easy.

According to the present invention, because pitch jump is prevented from occurring due to the external thread portion being provided on the distal end portion of the mandrel, the task of inserting an insert can be performed easily, and it is possible to essentially eliminate the time which has conventionally been required to perform a recovery operation in the event of pitch jump occurring. Accordingly, workability when an insert is being inserted can thus be improved markedly compared with the prior art.

Moreover, because the structure is considerably simplified compared with a conventional prewinder type of tool, the tool is comparatively low in cost and is extremely user-friendly in that it can be used with both manually driven systems and automatically driven systems.

### BRIEF DESCRIPTION OF THE DRAWINGS

FIG. 1A is a side view showing the schematic structure of an embodiment of the insertion tool for a tanged insert of the present invention.

FIG. 1B is a side cross-sectional view showing the schematic structure of an embodiment of the insertion tool for a tanged insert of the present invention.

FIG. 2 is an exploded view of the insertion tool for a tanged insert shown in FIG. 1.

FIG. 3A is a side view showing the structure of a tanged insert.

FIG. 3B is a front view showing the structure of a tanged insert.

FIG. 3C is a rear view showing the structure of a tanged insert.

FIG. 4A is a plan view showing the configuration of a distal end portion of an internal thread portion.

FIG. 4B is a side view of principal portions showing the configuration of the distal end portion of the internal thread portion.

FIG. 4C is a side view of principal portions seen from a different angle from that in FIG. 4B showing the configuration of the distal end portion of the internal thread portion.

FIG. 5A is a side view to illustrate the screwing in of a tanged insert in a tapped hole.

FIG. 5B is a plan view showing a state in which a tanged insert has been screwed into an internal thread portion.

FIG. 6 is a schematic structural view of a power driver.

FIG. 7A is a side view to illustrate the screwing in of a tanged insert into a tapped hole using a conventional slot type insertion tool.

FIG. 7B is a plan view showing a state in which a tanged insert has been screwed into an internal thread portion using a conventional slot type insertion tool.

### DETAILED DESCRIPTION OF THE INVENTION

The present invention will now be described in detail.

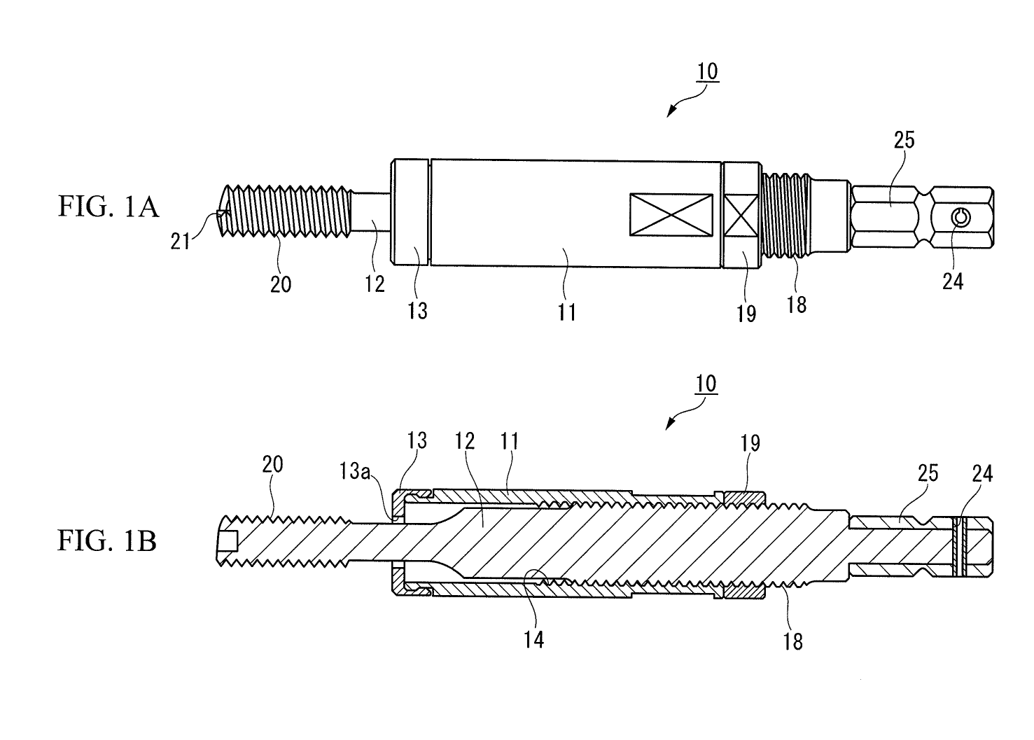

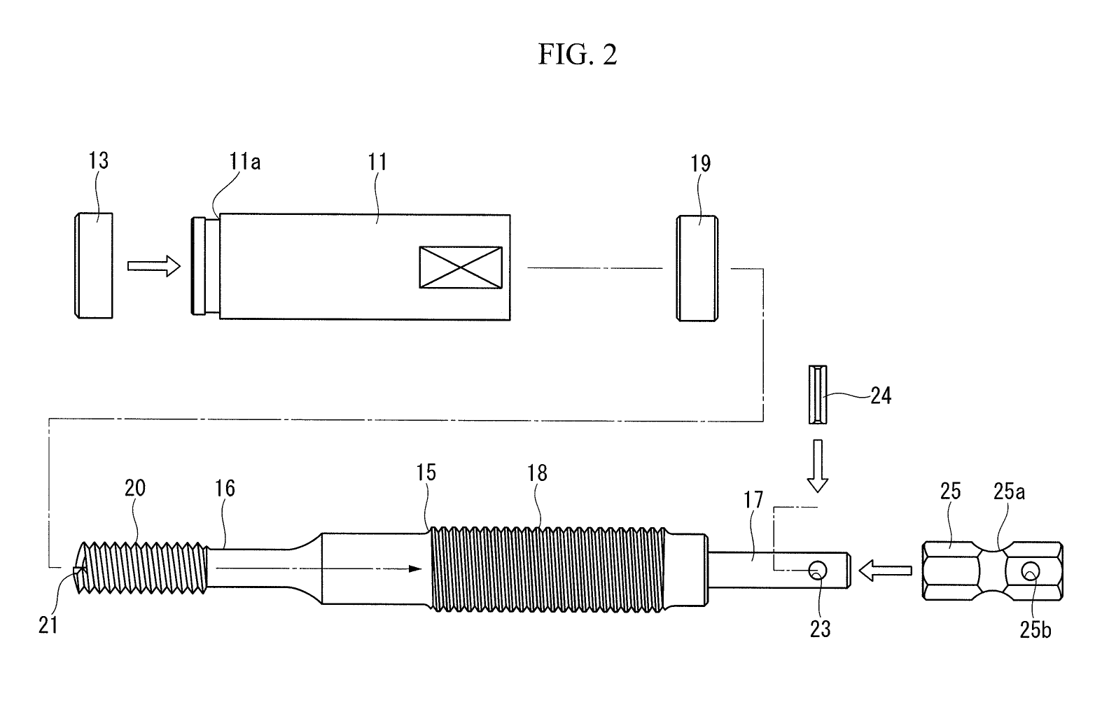

FIGS. 1 and 2 are views showing an embodiment of the tanged insertion tool of the present invention. FIG. 1A is a side view of a tanged insert insertion tool, while FIG. 1B is a side cross-sectional view of the same. FIG. 2 is an exploded view of a tanged insert insertion tool. In these drawings, the symbol 10 shows a tanged insert insertion tool (referred to below as an insertion tool).

This insertion tool 10 is provided with a tubular (i.e., a circular cylinder-shaped) housing 11, and with a mandrel 12 which is inserted while it is fitted inside the housing 11. As is shown in FIG. 2, a mounting groove 11a is formed on one end side of the housing 11, and a guard 13 is forcibly fitted onto this mounting groove 11a so as to cover the mounting groove 11a. The guard 13 is formed in the shape of a circular cylinder having a closed lid from a synthetic resin such as Nylon (registered trademark) or the like. Because the guard 13 has flexibility and has excellent capabilities for elastic deformation, it functions as a cushion (i.e., as a shock absorbing material). As is shown in FIG. 1B, a through hole 13a is formed in the lid portion of this guard 13.

Moreover, an internal thread 14 is formed in the housing 11 extending from a central portion thereof towards the rear end side (i.e., towards the opposite side from the mounting groove 11a). The internal thread 14 is threaded together with an external thread formed on the mandrel 12 so that the mandrel 12 is held integrally with the interior of the housing 11.

As is shown in FIG. 2, the mandrel 12 is formed by a central portion 15 having a relatively large diameter, a distal end portion 16 having a smaller diameter compared to the central portion, and a rear end portion 17 having an even smaller diameter than that of the distal end portion 15.

An external thread 18 is formed on the central portion 15 extending from a middle portion thereof towards the rear end. This external thread 18 is threaded together with the internal thread 14 which is formed on the housing 11 as is described above, so that, as a result, the mandrel 12 is held integrally with the interior of the housing 11. Moreover, a lock nut 19 is screwed onto this external thread 18 on the rear end portion 17 side as is shown in FIG. 1B. When the lock nut 19 is screwed onto the external thread 18, it becomes pushed hard up against the rear end of the housing 11 so as to fix the mandrel 12 integrally with the housing 11.

An external thread portion 20 which is threaded together with the tanged insert TI is formed on the distal end side of the distal end portion 16 of the mandrel 12.

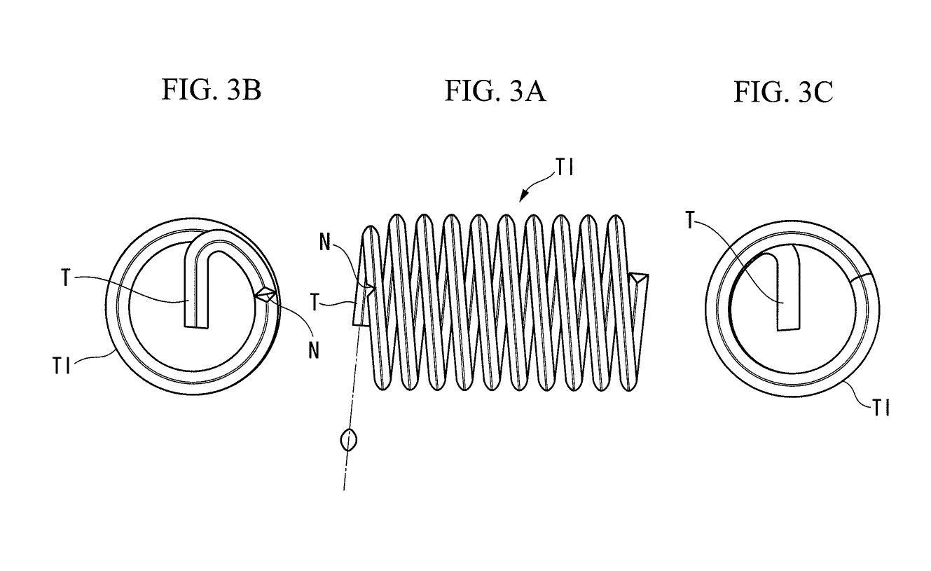

As is shown in FIG. 3A, FIG. 3B, and FIG. 3C, the tanged insert TI is formed from a wire material having a diamond-shaped cross-section, and is formed as a coil having an external thread and an internal thread formed respectively on the outer circumferential surface and the inner circumferential surface thereof. A tang T which forms a catching portion is formed by bending one end portion of the wire material inwards.

A notch N which is used to break off the tang is formed adjacent to the tang T. As a result, after the tanged insert TI has been inserted into the tapped hole (i.e., the internal thread portion) as is described above, the tang T can be broken off using this notch N.

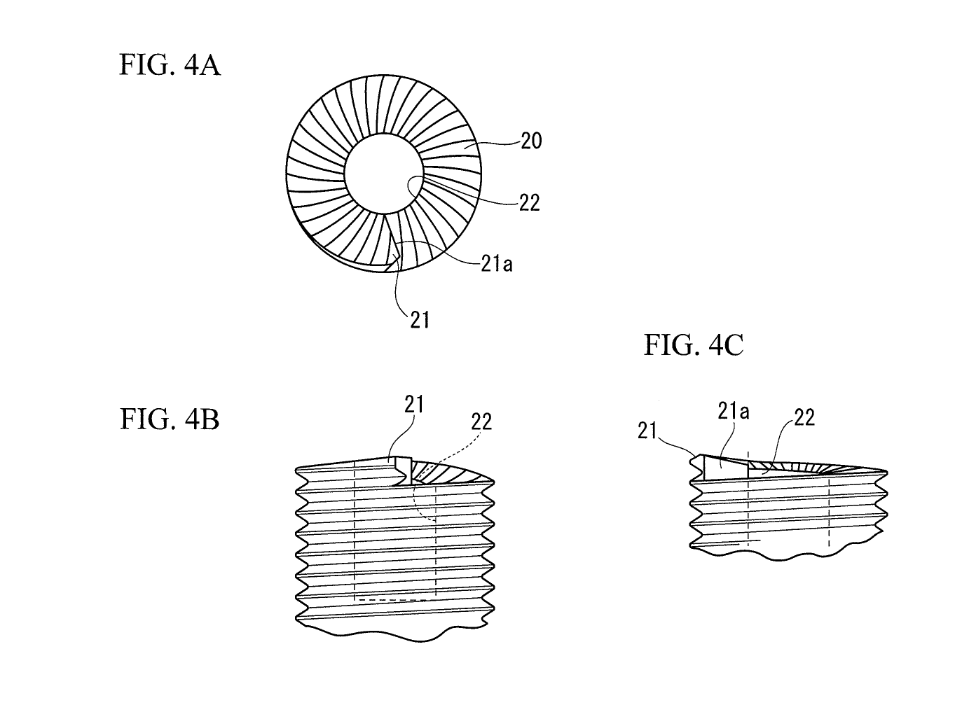

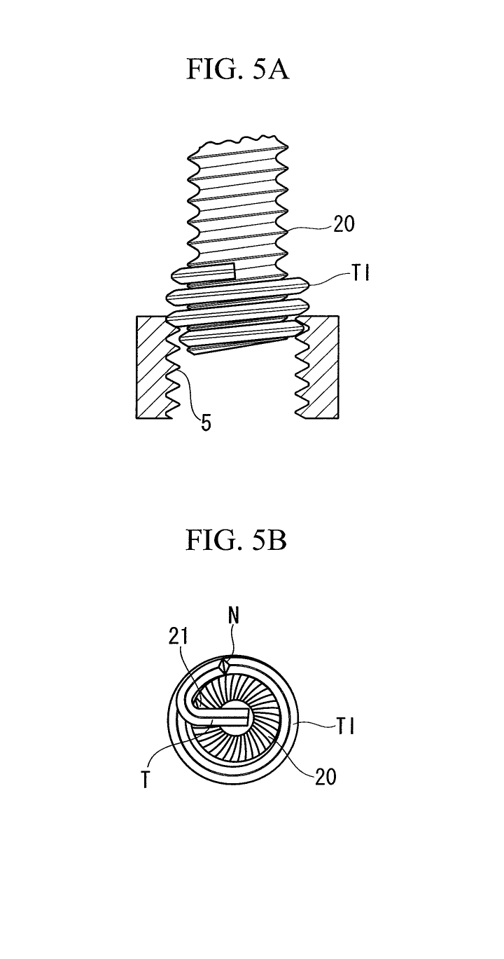

Moreover, an engaging portion 21 is formed on a distal end portion of the external thread portion 20. As is shown in FIG. 4A, FIG. 4B, and FIG. 4C, the engaging portion 21 is formed by a single coil at the endmost point of the external thread portion 20, namely, by the endmost portion of the helically wound spiral portion, and an inward facing surface thereof forms an engaging surface 21a. This engaging portion 21 is formed such that when the external thread portion 20 has been screwed into the tanged insert TI, as is shown in FIG. 5B, this engaging surface 21a engages with the inwardly bent portion of the tang T of the tanged insert TI.

Note that, as is shown in FIG. 4A, FIG. 4B, and FIG. 4C, a recessed portion 22 is formed in the distal end portion of the external thread portion 20.

As is shown in FIG. 2, a pinhole 23 is formed in the rear end portion 17 of the mandrel 12, and a spring pin 24 is inserted through this pinhole 23. A hexagonal bit 25 is placed over the rear end portion 17 and is fixed in position by means of the spring pin 24. The hexagonal bit 25 is shaped as a substantially hexagonal cylinder having an engaging groove 25a, and having an insertion hole 25b through which the spring pin 24 is inserted. The hexagonal bit 25 thus forms a connecting portion which can be removably connected to the driveshaft of a power driver or to a manually driven rotating jig or the like.

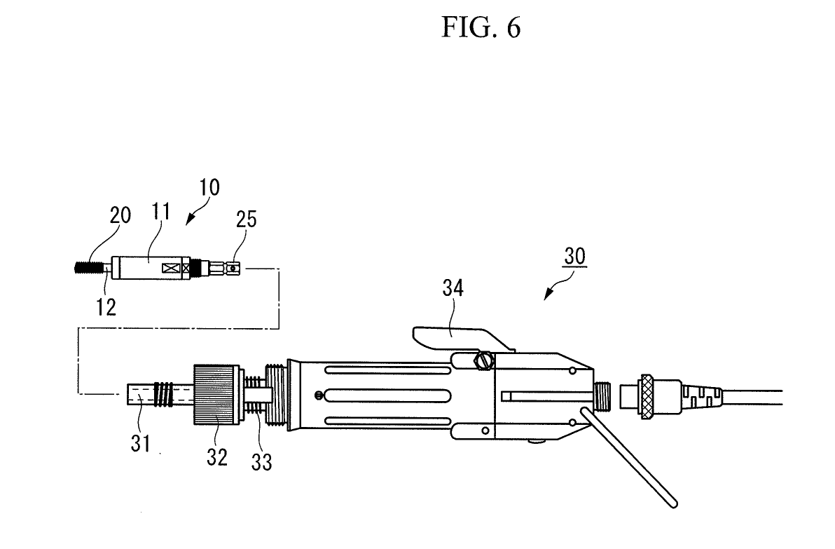

Here, when the insertion tool 10 of the present embodiment is used in an automatically driven system, then, for example, the power driver 30 shown in FIG. 6 can be used. The power driver 30 is a known power driver having a torque adjustment mechanism, and has a driveshaft 31 on the distal end side thereof. A torque adjustment nut 32 and a torque adjustment bolt 33 which is threaded inside the torque adjustment nut 32 are provided on the rear end side of the driveshaft 31. A connecting hole (not shown) which engages with the hexagonal bit 25 is formed in the driveshaft 31 facing towards the rear end side from the distal end. Note that a torque adjustment section is formed by the torque adjustment nut 32 and the torque adjustment bolt 33. A torque adjustment mechanism (not shown) in which the amount of torque of the driveshaft 31 and the force (i.e., the load) when a limit switch is operated are set by this torque adjustment section is incorporated on the rear end side of this torque adjustment section.

Moreover, a motor (not shown) which is used to rotate the driveshaft 31 is incorporated on the rear end side of this torque adjustment mechanism. Furthermore, a reversal mechanism (not shown) which is used to rotate the driveshaft 31 in reverse when the limit switch is put into operation by the torque adjustment mechanism is provided on a rotation shaft of this motor. Furthermore, a trigger switch 34 which is used to drive the motor is provided on an outer circumferential portion of this power driver 30.

When the insertion tool 10 of the present embodiment is mounted on the power driver 30 having the above described structure, the hexagonal bit 25 is inserted into the connecting hole in the driveshaft 31, so that the hexagonal bit 25 is firmly held and cannot be rotated relative to the driveshaft 31.

Moreover, when the insertion tool 10 of the present embodiment is used in a manually driven system, the insertion tool 10 is mounted on a connecting portion of a manually driven rotating jig (not shown) which is provided with, for example, a connecting portion (not shown) which is connected to the hexagonal bit 25, and with a handle (not shown) which is provided integrally with this connecting portion.

In order to mount the tanged insert TI in a tapped hole in the base material using the insertion tool 10 having the above described structure, firstly, the mandrel 12 is inserted through the housing 11 which has been closed off in advance by the guard 13, and the distal end portion of the mandrel 12 is inserted through the through hole 13a in the guard 13. Next, the external thread 18 of the mandrel 12 is threaded together with the internal thread 14 of the housing 11, and the threading together of these two is adjusted such that the distal end portion of the mandrel 12 which is protruding from the through hole 13a in the guard 13 is a desired length. In this state, the lock nut 19 is placed over the mandrel 12 from the rear end side thereof and is then threaded onto the external thread 18. In this manner, the lock nut 19 is threaded onto the external thread 18, and is screwed onto the external thread 18 until it is tight against the rear end of the housing 11. As a result, the mandrel 12 can be fixed in the housing 11.

Here, a protrusion length adjustment mechanism of the present invention which is used to adjust the length of the distal end portion of the mandrel 12 which is protruding from the through hole 13a in the guard 13 is formed by the internal thread 14 of the housing 11, the external thread 18 of the mandrel 12, and the lock nut 19.

Next, by connecting the hexagonal bit 25 to the power driver 30, or by connecting it to a rotating jig, the insertion tool 10 is attached to the power driver 30 or to the rotating jig.

Next, in this state, the external thread portion 20 at the distal end of the mandrel 12 is threaded into the tanged insert TI.

Namely, by driving the power driver 30 and thereby causing the insertion tool 10 to be automatically rotated, or by manually driving the rotating jig and thereby causing the insertion tool 10 to be rotated, the external thread portion 20 is screwed into the tanged insert TI. Alternatively, it is also possible to turn the tanged insert TI by hand and thus screw it onto the external thread portion 20.

When the external thread portion 20 is screwed into the tanged insert TI in this manner, the coils at the endmost tip of the external thread portion 20, namely, the endmost portion of the helically wound spiral portion create the engaging portion 21, and when this engaging portion 21 is screwed in, it meshes perfectly with the tang T and, as is shown in FIG. 5B, it becomes securely engaged with the tang T.

Next, as is shown in FIG. 5A, the distal end of the tanged insert TI which is threaded together with the external thread portion 20 is inserted into a tapped hole 5 formed in a base material. In this state, the power driver 30 is driven or the rotating jig is rotated thereby rotating the insertion tool 10.

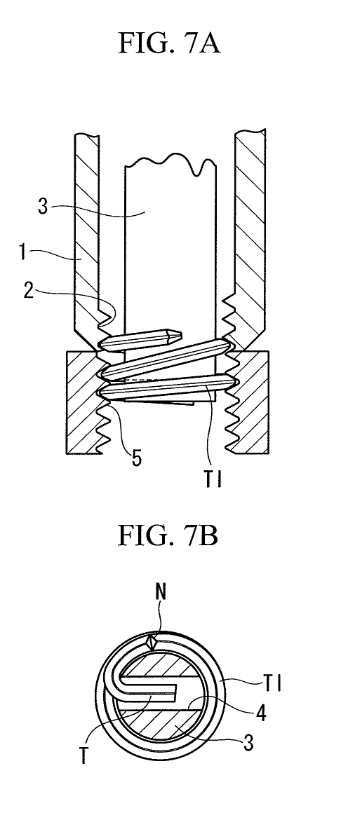

As a result, the distal end portion of the mandrel 12 and the external thread portion 20 are also rotated. Accordingly, the tanged insert TI whose tang T is engaged with the engaging portion 21 of the external thread portion 20 is also rotated, and is consequently moved forward while being screwed into the tapped hole 5. At this time, because the tanged insert TI is threaded together with the external thread portion 20, the pitches of the insert TI do not jump over the internal thread of the tapped hole 5, as is shown in FIG. 7A, and the respective pitches are moved forward in proper sequence over the internal thread of the tapped hole 5 by the external thread portion 20, as is shown in FIG. 5A, so that a proper fitting together is achieved. Accordingly, the occurrence of pitch jump is reliably prevented.

Note that when the tanged insert TI is threaded manually using a rotating jig, if the pitches start to jump, an abnormally strong force acts on the rotating jig. Accordingly, an operator is able to easily sense this and prevent pitch jump from occurring before it actually happens. If the tanged insert TI is threaded automatically using the power driver 30, then if a large load which is greater than the torque which has been set in advance is applied to the power driver 30, the driveshaft 31 is automatically reversed. As a result, it is possible to prevent pitch jump from occurring before it actually happens.

When the tanged insert TI has been inserted into the tapped hole 5 in this manner and has been screwed in as far as a preset depth, the guard 13 comes into contact with the surface where the aperture portion of the tapped hole 5 is formed. As a result, the distal end portion of the mandrel 12 (i.e., the external thread portion 20) is not able to move forward any further inside the tapped hole 5. Namely, the guard 13 functions as a stopper to determine the insertion depth of the distal end portion of the mandrel 12. In addition, as a result of the guard 13 coming up against the surface where the aperture portion of the tapped hole 5 is formed, the guard 13 which is made of resin functions as a shock absorber, and any damage to the base material in which the tapped hole 5 is formed or to the housing 11 is prevented.

Thereafter, by reversing the rotation direction of the driveshaft 31 of the power driver 30, or by reversing the rotation direction of the rotating jig, the insertion tool 10 is rotated in the reverse direction and the external thread portion 20 becomes unscrewed from the tanged insert TI. Next, the mandrel 12 is disconnected from the tanged insert TI and is extracted from the tapped hole 5. As a result, the tanged insert TI is able to be inserted and screwed into the tapped hole 5.

Note that, in the same way as in the prior art, the tanged insert TI which has been screwed into the tapped hole 5 in this manner breaks off the tang T using the tang break-off notch N, thereby making it possible for a bolt to be screwed into the tanged insert TI.

This insertion tool 10 has the external thread portion 20 on the distal end portion of the mandrel 12 so that even without a fastening nut such as is used in a conventional prewinder type tool, it is possible to reliably prevent pitch jump from occurring. Accordingly, the task of inserting an insert TI can be performed easily, and it is possible to essentially eliminate the time which has conventionally been required to perform a recovery operation in the event of pitch jump occurring. Workability when an insert is being inserted can thus be improved markedly compared with the prior art.

Moreover, because the fastening nut is no longer required, disadvantages such as a complex structure and high manufacturing costs which are inherent in a conventional prewinder type tool can be eliminated, resulting in a simplified structure and a low-cost tool which is difficult to break.

Because the structure is simple, it can be used with both manually driven systems and automatically driven systems, and is thus extremely user-friendly in that it allows a user to freely choose the system to be used. This is also advantageous cost-wise.

Note that the insertion tool for a tanged insert of the present invention is not limited to the above described embodiment, and various modifications may be made thereto insofar as they do not depart from the spirit or scope of the present invention. For example, in the above described embodiment, a guard 13 which is made of resin is used, however, provided that precedence is given to its function as a stopper, it is also possible to use a guard 13 which is made of metal in spite of the fact that its function as a shock absorber is deteriorated.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A tanged insert insertion tool comprising:
a housing; and
a mandrel which is inserted inside the housing such that a distal end portion thereof protrudes from one end side of the housing, wherein
an external thread portion which is threaded together with a tanged insert is provided on the distal end portion of the mandrel.

2. The tanged insert insertion tool according to claim 1, wherein one coil at an endmost portion of the external thread portion forms an engaging portion which is formed in a helically wound spiral shape.

3. The tanged insert insertion tool according to claim 1, wherein
a guard which is manufactured from resin in the shape of a circular cylinder having a closed lid covers one end side of the housing, and
the distal end portion of the mandrel protrudes from the one end side of the housing through a through hole which is formed in the guard.

4. The tanged insert insertion tool according to claim 2, wherein
a guard which is manufactured from resin in the shape of a circular cylinder having a closed lid covers one end side of the housing, and
the distal end portion of the mandrel protrudes from the one end side of the housing through a through hole which is formed in the guard.

5. The tanged insert insertion tool according to any one of claims 1 through 4, wherein there is provided a protrusion length adjustment mechanism which adjusts the length of the distal end portion which is protruding from the one end side of the housing.
